(19) United States
(12) Patent Application Publication
(10) Pub. No.: US 2026/0236175 A1
(43) Pub. Date: Aug. 13, 2026

(54) DISTRIBUTED REDUNDANCY METADATA IN A MEMORY SUB-SYSTEM

(71) Applicant: Micron Technology, Inc., Boise, ID (US)

(72) Inventors: Cory Michael Steinmetz, Boise, ID (US); Kyle Wilkins, Meridian, ID (US); Michael G. Miller, Boise, ID (US); Gary F. Besinga, Boise, ID (US); Roy Leonard, San Jose, CA (US)

(21) Appl. No.: 19/051,072

(22) Filed: Feb. 11, 2025

(51) Int. Cl. G06F 3/06

(52) U.S. Cl. CPC G06F 3/0616; G06F 3/0659; G06F 3/0679

(57) ABSTRACT

A system includes a memory device and a processing device operatively coupled with the memory device to perform operations including determining first redundancy metadata for first data to be written to a first section of the memory device, determining whether a first set of redundancy metadata comprising the first redundancy metadata satisfies a write threshold, and responsive to determining the first set of redundancy metadata satisfies the write threshold, writing the first set of redundancy metadata to a second section of the memory device.

### TECHNICAL FIELD

Embodiments of the disclosure relate generally to memory sub-systems, and, more specifically, relate to implementing distributed redundancy metadata in a memory sub-system.

### BACKGROUND

A memory sub-system can include one or more memory devices that store data. The memory devices can be, for example, non-volatile memory devices and volatile memory devices. In general, a host system can utilize a memory sub-system to store data at the memory devices and to retrieve data from the memory devices.

### BRIEF DESCRIPTION OF THE DRAWINGS

The disclosure will be understood more fully from the detailed description given below and from the accompanying drawings of various embodiments of the disclosure. The drawings, however, should not be taken to limit the disclosure to the specific embodiments, but are for explanation and understanding only.

FIG. 1 illustrates an example computing system that includes a memory sub-system, in accordance with some embodiments of the present disclosure.

FIG. 2A is an example block diagram of a logical representation of various memory planes that are accessible by multiple memory interface channels, according to some aspects of the disclosure.

FIG. 2B illustrates how data written to a memory device maps to redundancy metadata written to the memory device, according to some aspects of the disclosure.

FIG. 3 is an example block diagram of a logical representation of two blocks that each include various memory planes that are accessible by multiple memory interface channels, according to some aspects of the disclosure.

FIG. 4 is an example block diagram of a logical representation of various memory planes that are accessible by multiple memory interface channels, according to some aspects of the disclosure.

FIG. 5 is a flow diagram of an example method to implement distributed redundancy metadata in a memory sub-system, according to some aspects of the disclosure.

FIG. 6 is a flow diagram of an example method to implement distributed redundancy metadata in a memory sub-system, according to some aspects of the disclosure.

FIG. 7 is a flow diagram of an example method to implement distributed redundancy metadata in a memory sub-system, according to some aspects of the disclosure.

FIG. 8 is a block diagram of an example computer system in which embodiments of the present disclosure may operate.

### DETAILED DESCRIPTION

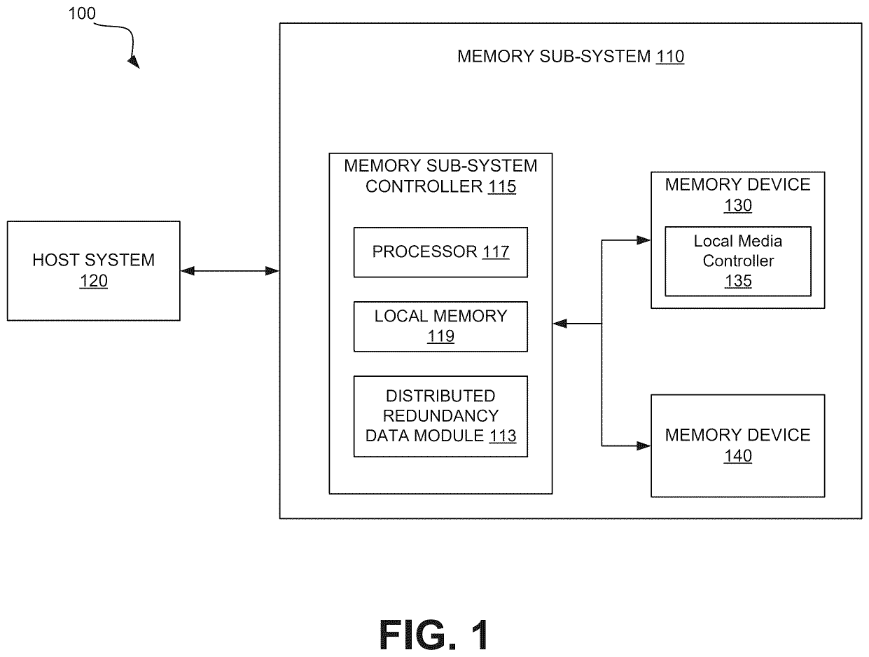

Aspects of the present disclosure are directed to implementing distributed redundancy metadata in a memory sub-system. A memory sub-system can be a storage device, a memory module, or a combination of a storage device and a memory module. Examples of storage devices and memory modules are described below in conjunction with FIG. 1. In general, a host system can utilize a memory sub-system that includes one or more components, such as memory devices that store data. The host system can provide data to be stored at the memory sub-system and can request data to be retrieved from the memory sub-system.

A memory sub-system can include high-density non-volatile memory devices where retention of data is desired when no power is supplied to the memory device. One example of a non-volatile memory device is a negative-AND (NAND) memory device. Other examples of non-volatile memory devices are described below in conjunction with FIG. 1. A non-volatile memory device is a package of one or more dies. Each die includes one or more planes. For some types of non-volatile memory devices (e.g., NAND devices), each plane includes a set of physical blocks. Each block consists of a set of pages. Each page includes a set of memory cells. A memory cell is an electronic circuit that stores information. Depending on the memory cell type, a memory cell can store one or more bits of binary information and has various logic states that correlate to the number of bits being stored. The logic states can be represented by binary values, such as “0” and “1”, or combinations of such values.

A memory device can include multiple memory cells arranged in a two-dimensional grid. The memory cells are formed onto a silicon wafer in an array of columns and rows. A memory cell includes a capacitor that holds an electric charge and a transistor that acts as a switch controlling access to the capacitor. Accordingly, the memory cell can be programmed (written to) by applying a certain voltage, which results in an electric charge being held by the capacitor. The memory cells are joined by wordlines, which are conducting lines electrically connected to the control gates of the memory cells, and bitlines, which are conducting lines electrically connected to the drain electrodes of the memory cells. A block hereinafter refers to a unit of the memory device used to store data and can include a group of memory cells, a wordline group, a wordline, or individual memory cells. One or more blocks can be grouped together to form separate partitions (e.g., planes) of the memory device in order to allow concurrent operations to take place on each plane. The memory device can include circuitry that performs concurrent memory page accesses of two or more memory planes. For example, the memory device can include multiple access line driver circuits and power circuits that can be shared by the planes of the memory device to facilitate concurrent access of pages of two or more memory planes, including different page types. For ease of description, these circuits can be generally referred to as independent plane driver circuits. Depending on the storage architecture employed, data can be stored across the memory planes (i.e., in stripes). Accordingly, one request to read a segment of data (e.g., corresponding to one or more data addresses), can result in read operations performed on two or more of the memory planes of the memory device.

Some memory devices can be three-dimensional (3D) memory devices (e.g., 3D NAND devices). For example, a 3D memory device can include memory cells that are placed between sets of layers including a pillar (e.g., polysilicon pillar), a tunnel oxide layer, a charge trap (CT) layer, and a dielectric (e.g., oxide) layer. For example, a 3D memory device can be a 3D replacement gate memory device having a replacement gate structure using wordline stacking.

The memory sub-system can perform host-initiated memory access operations. For example, the host system can initiate a data operation (e.g., write, read, erase, etc.) on a memory sub-system. The host system can send access requests (e.g., write command or read command) to the memory sub-system, such as to store data on a memory device at the memory sub-system and to read data from the memory device on the memory sub-system. The data to be read or written, as specified by a host request, is hereinafter referred to as “host data.” A host request can include logical address information (e.g., logical block address (LBA), namespace) for the host data, which is the location the host system associates with the host data. The logical address information (e.g., LBA, namespace) can be part of metadata for the host data. Metadata can also include error handling data (e.g., ECC codeword, parity code), data version (e.g. used to distinguish age of data written), valid bitmap (which LBAs or logical transfer units contain valid data), etc.

A memory cell (“cell”) can be programmed (e.g., written to) by applying a certain voltage to the cell, which results in an electric charge being held by the cell. For example, a voltage signal V_{CG} can be applied to a control electrode of the cell to open the cell to the flow of electric current across the cell between a source electrode and a drain electrode. More specifically, for each individual cell (having a charge Q stored thereon), there can be a threshold control gate voltage V_{T} (also referred to as the “threshold voltage”) such that the source-drain electric current is low for the control gate voltage (V_{CG}) being below the threshold voltage, V_{CG}<V_{T}. The current increases substantially once the control gate voltage has exceeded the threshold voltage, V_{CG}>V_{T.} Because the actual geometry of the electrodes and gates varies from cell to cell, the threshold voltages can be different even for cells implemented on the same die. The cells can, therefore, be characterized by a distribution P of the threshold voltages, P(Q, V_{T})=dW/dV_{T}, where dW represents the probability that any given cell has its threshold voltage within the interval [V_{T}, V_{T}+dV_{T}] when charge Q is placed on the cell.

A memory device can exhibit threshold voltage distributions P(Q, V_{T}) that are narrow compared with the working range of control voltages tolerated by the cells of the device. Accordingly, multiple non-overlapping distributions P(Qₖ, V_{T}) (“valleys”) can be fit into the working range, allowing for storage and reliable detection of multiple values of the charge Qₖ, k=1, 2, 3 . . . The distributions (valleys) are interspersed with voltage intervals (“valley margins”) where none (or very few) of the cells of the device have their threshold voltages. Such valley margins can, therefore, be used to separate various charge states Qₖ. The logical state of the cell can be determined by detecting, during a read operation, between which two valley margins the respective threshold voltage V_{T} of the cell resides. Specifically, the read operation can be performed by comparing the measured threshold voltage V_{T} exhibited by the memory cell to one or more reference voltage levels corresponding to known valley margins (e.g., centers of the margins) of the memory device.

One type of cell is a single level cell (SLC), which stores 1 bit per cell and defines 2 logical states (“states”) (“1” or “L0” and “0” or “L1”), each corresponding to a respective V_{T} level. For example, the “1” state can be an erased state (L0), and the “0” state can be a programmed state (L1). Another type of cell is a multi-level cell (MLC), which stores 2 bits per cell and defines 4 states (“11” or “L0”, “10” or “L1”, “01” or “L2” and “00” or “L3”), each corresponding to a respective V_{T} level. For example, the “11” state can be an erased state, and the “01”, “10” and “00” states can each be a respective programmed state. Another type of cell is a triple level cell (TLC), which stores 3 bits per cell and defines 8 states (“111” or “L0”, “110” or “L1”, “101” or “L2”, “100” or “L3”, “011” or “L4”, “010” or “L5”, “001” or “L6”, and “000” or “L7”), each corresponding to a respective V_{T} level. For example, the “111” state can be an erased state, and each of the other states can be a respective programmed state. Another type of a cell is a quad-level cell (QLC), which stores 4 bits per cell and defines 16 states L0-L15, where L0 corresponds to “1111” and L15 corresponds to “0000”. Another type of cell is a penta-level cell (PLC), which stores 5 bits per cell and defines 32 states. Other types of cells are also contemplated. A memory device can include one or more arrays of memory cells such as SLCs, MLCs, TLCs, QLCs, PLCs, etc., or any combination of such. For example, a memory device can include an SLC portion, an MLC portion, a TLC portion, a QLC portion, or a PLC portion of cells.

A valley margin can also be referred to as a read window. For example, in an SLC cell, there is 1 read window that exists with respect to the 2 V_{T} distributions. As another example, in an MLC cell, there are 3 read windows that exist with respect to the 4 V_{T} distributions. As yet another example, in a TLC cell, there are 7 read windows that exist with respect to the 8 V_{T} distributions. Read window size generally decreases as the number of states increases. For example, the 1 read window for the SLC cell may be larger than each of the 3 read windows for the MLC cell, and each of the 3 read windows for the MLC cell may be larger than each of the 7 read windows for the TLC cell, etc. Read window budget (RWB) refers to the cumulative value of the read windows.

As data is repeatedly written and erased in a memory device, such as a flash memory, the memory device may be more susceptible to errors due to various types of noise and disturb mechanisms inherent within the memory cell, which may be exacerbated with repeated programming. As a result, the raw bit error rates (RBERs) for the memory device can increase over time. Given this pattern, the end-of-life RBERs for these devices are much higher as compared to the beginning-of-life RBERs for the respective devices.

To address read errors, a memory sub-system can use various error handling techniques to correct errors and verify that the data read from the memory device is the same as the data that was previously written to the respective memory device. In some embodiments, the error handling techniques can include performing one or more read retries using different parameters, such as a change in the threshold voltage offset as compared to the initial threshold voltage offset applied in performing a read operation on a set of memory cells.

Some error handling techniques can use redundancy metadata to correct errors in data written to the memory device. As used herein, “redundancy metadata,” refers to metadata that is generated from host data and allows the host data to be reconstructed in the event that the host data becomes corrupted. For example, redundancy metadata can include parity data, which may be calculated from the host data using mathematical operations such as an exclusive OR (XOR) operation. In another example, redundancy metadata can be generated and used in a redundant array of independent NAND (RAIN) to improve the reliability of a storage system. In a RAIN configuration, data such as host data is to be saved. A storage system generated redundancy metadata for the host data, and then writes a portion of the host data along with the generated redundancy metadata to multiple memory devices. For example, if the storage system had four memory devices, the storage system would generate redundancy metadata from the host data, separate the host data into four portions, and then write each portion to one of the four memory devices along with the generated redundancy metadata. Notably, the redundancy metadata can be generated for the data before it is separated into smaller portions that are written to memory devices, and thus the redundancy metadata represents a full set of host data that was written to a particular memory device, and not just the portion of the set of host data. In some systems, the redundancy metadata can be generated for the data that is written to a particular device.

The redundancy metadata can be stored alongside the host data in the memory device. However, this can impede the performance and long-term reliability of the memory device. When the redundancy metadata is stored alongside the host data, performing repeated memory operations on the memory device to read the redundancy metadata can cause excessive physical wear on the memory cells that contain host data. This is due in part to the minimal read threshold size for performing a read operation. That is, each time a read operation is performed, a minimum number of memory cells are accessed by the memory sub-system. When the redundancy metadata is smaller than the memory size of the minimum number of memory cells for a read operation, the content of the adjacent cells is still read read and discarded.

Additionally, memory sub-systems can include multiple memory interface channel interfaces to perform memory access operations in parallel. For example, two memory interface channels can each access different memory locations simultaneously. However, when all of the redundancy metadata that is stored on the memory device is only accessible by the same memory interface channel, memory access operations for the redundancy metadata cannot be performed in parallel, thus slowing down the read, write, and/or modification operations performed on the redundancy metadata. For example, when reading a large quantity of redundancy metadata (such as during a RAIN operation to recover data that was stored on a now-failed memory device), the memory device may be limited to the access speed of the memory interface channel that has access the redundancy metadata, as the remaining memory interface channels are idle. Additionally, when performing memory operations to read data (e.g., host data) from the memory device, the redundancy metadata is necessarily read and subsequently discarded as part of the memory operation. This lowers the efficiency and performance of the memory device when performing read operations, especially when performing read operations for a RAIN recovery operations.

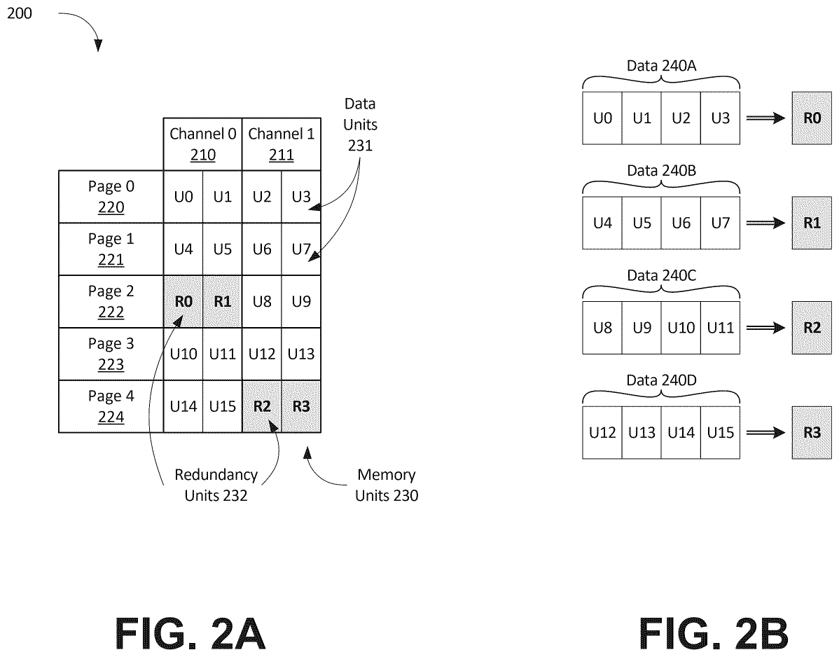

Aspects of the present disclosure address the above and other deficiencies by distributing redundancy metadata across the memory sub-system. When performing a write operation to write data to a memory device (e.g., host data), the memory sub-system can compute redundancy metadata for the data written by the write operation. As additional data (e.g., subsequent sets of host data) are written to the memory device, the memory sub-system can, compute and maintain temporary redundancy metadata for each subsequent set of host data in a set of temporary redundancy metadata. For example, each time new data is written by a write operation, new redundancy metadata is computed, and the newly computed redundancy metadata is added to the temporary set of redundancy metadata. Once the size of the temporary set of redundancy metadata satisfies a predefined write threshold, the memory sub-system can write the temporary set of redundancy metadata to the memory device. The predefined write threshold can be selected based on the size of data that can be written by a memory access operation. When the memory device performs a memory operation, a certain quantity of data is written, read, or modified as a unit. Once the unit has been processed by the memory operation (e.g., written, read, or modified) another unit (e.g., certain quantity of data) is processed by the memory operation. Thus, when the predefined write threshold is based on the certain quantity of data that is processed as a unity by a memory operation, when reading from memory, “units” that only contain redundancy metadata (which were written based on the write threshold) can be skipped over. This results in a memory access operation that can be performed on units that are full of redundancy metadata, and thus do not contain host data, which results in fast read times of redundancy metadata. When a memory sub-system includes multiple memory interface channels (e.g., memory interface channels that each access a respective memory die), host data can be written using each memory interface channel, and the temporary set of redundancy metadata can be written using one or a subset of memory interface channels. The predefined write threshold can be selected based on the number of memory planes that are accessible to a memory interface channel. The predefined write threshold can further be selected such that subsequent temporary sets of redundancy metadata are written by different memory interface channels. Additional details regarding writing the redundancy metadata by different memory interface channels are described below, particularly with reference to FIGS. 2A-4.

Advantages of the present disclosure include improved memory device performance and reliability. For example, embodiments described herein can achieve improved performance by accessing redundancy metadata using multiple memory interface channels as opposed to relying on a single channel to access redundancy metadata. Additionally, when the redundancy metadata is stored in chunks that correspond to the amount of data accessible by a single memory access operation, during read operations because those “chunks” only contain redundancy metadata, the chunks can be skipped over, providing additional read performance improvements when reading host data. Accordingly, embodiments described herein can be implemented to reduce read operation durations, reduce read operation throttling when reading redundancy metadata (e.g., during a RAIN recover operation), and increase the life and performance of a memory device.

The method described herein can be implemented with any suitable memory device architecture in accordance with the embodiments described herein. In one embodiment, the method can be implemented with a memory device implementing replacement gate NAND (RG NAND) technology. A replacement gate (RG) NAND device is a NAND device that implements a RG architecture rather than a floating gate (FG) architecture. The RG NAND architecture removes cell gaps that are typically found in FG NAND architectures, thereby reducing or eliminating capacitance resulting from those cell gaps. More specifically, the RG NAND architecture corresponds to a single-insulator structure. The RG NAND architecture can enable smaller size, improved read and write latency, and an increase in transfer rate as compared to the FG NAND architecture.

As used herein, “memory segment” can refer to a quantity of data that is writeable to group of adjacent memory locations in a memory device, such as memory cells, that are accessible by a single memory interface channel in a single memory operation. A memory structure such as a plane can include multiple memory segments, each corresponding to a respective memory interface channel that has respective access to the memory structure.

As used herein, “memory unit” can refer to a physical memory location, such as a memory cell (e.g., an SLC, TLC, QLC memory cell, etc.), or other distinct physical memory structure. Multiple physically adjacent memory units can be grouped together to form a memory segment.

FIG. 1 illustrates an example computing system 100 that includes a memory sub-system 110 in accordance with some embodiments of the present disclosure. The memory sub-system 110 can include media, such as one or more volatile memory devices (e.g., memory device 140), one or more non-volatile memory devices (e.g., memory device 130), or a combination of such.

A memory sub-system 110 can be a storage device, a memory module, or a combination of a storage device and memory module. Examples of a storage device include a solid-state drive (SSD), a flash drive, a universal serial bus (USB) flash drive, an embedded Multi-Media Controller (eMMC) drive, a Universal Flash Storage (UFS) drive, a secure digital (SD) card, and a hard disk drive (HDD). Examples of memory modules include a dual in-line memory module (DIMM), a small outline DIMM (SO-DIMM), and various types of non-volatile dual in-line memory modules (NVDIMMs).

The computing system 100 can be a computing device such as a desktop computer, laptop computer, network server, mobile device, a vehicle (e.g., airplane, drone, train, automobile, or other conveyance), Internet of Things (IoT) enabled device, embedded computer (e.g., one included in a vehicle, industrial equipment, or a networked commercial device), or such computing device that includes memory and a processing device.

The computing system 100 can include a host system 120 that is coupled to one or more memory sub-systems 110. In some embodiments, the host system 120 is coupled to multiple memory sub-systems 110 of different types. FIG. 1 illustrates one example of a host system 120 coupled to one memory sub-system 110. As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

The host system 120 can include a processor chipset and a software stack executed by the processor chipset. The processor chipset can include one or more cores, one or more caches, a memory controller (e.g., non-volatile dual in-line memory module (NVDIMM) controller), and a storage protocol controller (e.g., peripheral component interconnect express (PCIe) controller, serial advanced technology attachment (SATA) controller, compute express link (CXL) controller, etc.). The host system 120 uses the memory sub-system 110, for example, to write data to the memory sub-system 110 and read data from the memory sub-system 110.

The host system 120 can be coupled to the memory sub-system 110 via a physical host interface. Examples of a physical host interface include, but are not limited to, a SATA interface, a CXL interface, a PCIe interface, universal serial bus (USB) interface, Fibre Pillar, Serial Attached SCSI (SAS), a double data rate (DDR) memory bus, Small Computer System Interface (SCSI), a dual in-line memory module (DIMM) interface (e.g., DIMM socket interface that supports Double Data Rate (DDR)), etc. The physical host interface can be used to transmit data between the host system 120 and the memory sub-system 110. The host system 120 can further utilize an NVM Express (NVMe) interface to access components (e.g., memory devices 130) when the memory sub-system 110 is coupled with the host system 120 by the physical host interface (e.g., PCIe or CXL bus). The physical host interface can provide an interface for passing control, address, data, and other signals between the memory sub-system 110 and the host system 120. FIG. 1 illustrates a memory sub-system 110 as an example. In general, the host system 120 can access multiple memory sub-systems via a same communication connection, multiple separate communication connections, and/or a combination of communication connections.

The memory devices 130, 140 can include any combination of the different types of non-volatile memory devices and/or volatile memory devices. The volatile memory devices (e.g., memory device 140) can be, but are not limited to, random access memory (RAM), such as dynamic random access memory (DRAM) and synchronous dynamic random access memory (SDRAM).

Some examples of non-volatile memory devices (e.g., memory device 130) include a not-AND (NAND) type flash memory and write-in-place memory, such as a three-dimensional cross-point (“3D cross-point”) memory device, which is a cross-point array of non-volatile memory cells. A cross-point array of non-volatile memory cells can perform bit storage based on a change of bulk resistance, in conjunction with a stackable cross-gridded data access array. Additionally, in contrast to many flash-based memories, cross-point non-volatile memory can perform a write in-place operation, where a non-volatile memory cell can be programmed without the non-volatile memory cell being previously erased. NAND type flash memory includes, for example, two-dimensional NAND (2D NAND) and three-dimensional NAND (3D NAND).

Each of the memory devices 130 can include one or more arrays of memory cells. One type of memory cell, for example, single-level memory cells (SLC), can store one bit per memory cell. Other types of memory cells, such as multi-level memory cells (MLCs), triple-level memory cells (TLCs), quad-level memory cells (QLCs), and penta-level memory cells (PLCs) can store multiple bits per memory cell. In some embodiments, each of the memory devices 130 can include one or more arrays of memory cells such as SLCs, MLCs, TLCs, QLCs, PLCs, or any combination of such. In some embodiments, a particular memory device can include an SLC portion, an MLC portion, a TLC portion, a QLC portion, or a PLC portion of memory cells. The memory cells of the memory devices 130 can be grouped as pages that can refer to a logical unit of the memory device used to store data. With some types of memory (e.g., NAND), pages can be grouped to form blocks.

Although non-volatile memory components such as a 3D cross-point array of non-volatile memory cells and NAND type flash memory (e.g., 2D NAND, 3D NAND) are described, the memory device 130 can be based on any other type of non-volatile memory, such as read-only memory (ROM), phase change memory (PCM), self-selecting memory, other chalcogenide-based memories, ferroelectric transistor random-access memory (FeTRAM), ferroelectric random access memory (FeRAM), magneto random access memory (MRAM), Spin Transfer Torque (STT)-MRAM, conductive bridging RAM (CBRAM), resistive random access memory (RRAM), oxide-based RRAM (OxRAM), negative-or (NOR) flash memory, or electrically erasable programmable read-only memory (EEPROM).

A memory sub-system controller 115 (or controller 115 for simplicity) can communicate with the memory devices 130 to perform operations such as reading data, writing data, or erasing data at the memory devices 130 and other such operations. The memory sub-system controller 115 can include hardware such as one or more integrated circuits and/or discrete components, a buffer memory, or a combination thereof. The hardware can include a digital circuitry with dedicated (i.e., hard-coded) logic to perform the operations described herein. The memory sub-system controller 115 can be a microcontroller, special purpose logic circuitry (e.g., a field programmable gate array (FPGA), an application-specific integrated circuit (ASIC), etc.), or another suitable processor.

The memory sub-system controller 115 can include a processing device, which includes one or more processors (e.g., processor 117), configured to execute instructions stored in a local memory 119. In the illustrated example, the local memory 119 of the memory sub-system controller 115 includes an embedded memory configured to store instructions for performing various processes, operations, logic flows, and routines that control the operation of the memory sub-system 110, including handling communications between the memory sub-system 110 and the host system 120.

In some embodiments, the local memory 119 can include memory registers storing memory pointers, fetched data, etc. The local memory 119 can also include read-only memory (ROM) for storing micro-code. While the example memory sub-system 110 in FIG. 1 has been illustrated as including the memory sub-system controller 115, in another embodiment of the present disclosure, a memory sub-system 110 does not include a memory sub-system controller 115, and can instead rely upon external control (e.g., provided by an external host, or by a processor or controller separate from the memory sub-system).

In general, the memory sub-system controller 115 can receive commands or operations from the host system 120 and can convert the commands or operations into instructions or appropriate commands to achieve the desired access to the memory devices 130. The memory sub-system controller 115 can be responsible for other operations such as wear leveling operations, garbage collection operations, error detection and error correcting code (ECC) operations, encryption operations, caching operations, and address translations between a logical address (e.g., a logical block address (LBA), namespace) and a physical address (e.g., physical block address) that are associated with the memory devices 130. The memory sub-system controller 115 can further include host interface circuitry to communicate with the host system 120 via the physical host interface. The host interface circuitry can convert the commands received from the host system into command instructions to access the memory devices 130 as well as convert responses associated with the memory devices 130 into information for the host system 120.

The memory sub-system 110 can also include additional circuitry or components that are not illustrated. In some embodiments, the memory sub-system 110 can include a cache or buffer (e.g., DRAM) and address circuitry (e.g., a row decoder and a column decoder) that can receive an address from the memory sub-system controller 115 and decode the address to access the memory devices 130.

In some embodiments, the memory devices 130 include local media controllers 135 that operate in conjunction with memory sub-system controller 115 to execute operations on one or more memory cells of the memory devices 130. An external controller (e.g., memory sub-system controller 115) can externally manage the memory device 130 (e.g., perform media management operations on the memory device 130). In some embodiments, memory sub-system 110 is a managed memory device, which is a raw memory device 130 having control logic (e.g., local media controller 135) on the die and a controller (e.g., memory sub-system controller 115) for media management within the same memory device package. An example of a managed memory device is a managed NAND (MNAND) device.

The memory sub-system controller 115 can implement a distributed redundancy metadata module 113. The distributed redundancy metadata module 113 can determine redundancy metadata for host data to be written to the memory device 130 of the memory sub-system 110. In some embodiments, the distributed redundancy metadata module 113 receives redundancy metadata with the host data that is to be written. For example, the host data to be written may be a portion of a larger host data that has been separated into smaller portions, and the redundancy metadata can be redundancy metadata that was generated for the larger host data before the host data was split into the smaller portions. In alternative embodiments, the distributed redundancy metadata module 113 can generate redundancy metadata for the host data to be written. For example, the host data can be received by the memory sub-system 110, and the distributed redundancy metadata module 113 can generate redundancy metadata for the host data.

The distributed redundancy metadata module 113 can track the amount of redundancy metadata that has been received or generated (e.g., determined) for each host data that is written to the memory device 130. In some embodiments, as the memory sub-system 110 writes data to the memory device 130, corresponding redundancy metadata is written to a memory cache, such as a short-term or volatile memory (not illustrated). In some embodiments, the memory cache is included in the distributed redundancy metadata module 113. In alternative embodiments, the distributed redundancy metadata module 113 can access a memory cache, such as a portion of the memory device 140 that is dedicated to storing redundancy metadata for the distributed redundancy metadata module 113. In another embodiment, the memory cache is part of a memory cache pool in a volatile memory device that is not dedicated for any particular usage, but is allocated and used by components of the memory sub-system 110 as needed.

As the memory sub-system 110 writes data to the memory device 130 and generates corresponding redundancy metadata (e.g., to a redundancy memory cache), the distributed redundancy metadata module 113 can determine whether a quantity of generated redundancy metadata satisfies a predetermined threshold (e.g., a write threshold). In some embodiments, the predetermined threshold is based on a number of memory locations (e.g., memory units) that are accessible by a single memory interface channel for a single memory operation (e.g., a memory segment). That is, in some embodiments, the value of the predetermined threshold can be the same as the number of memory locations that are accessible by a single memory interface channel for a single memory operation. Once the distributed redundancy metadata module 113 determines that a quantity of redundancy metadata in the redundancy cache satisfies the predetermined threshold, the distributed redundancy metadata module 113 can cause the memory sub-system to write the respective set of redundancy metadata to the memory device. In some embodiments, the entirety of the redundancy cache is written to the memory device. In such embodiments, the predetermined threshold can be set based on the size of the redundancy cache and when the redundancy cache is full, the write threshold is satisfied.

In some embodiments, the write threshold is based on one or more parameters that track where a most recent redundancy metadata was written. For example, the distributed redundancy metadata module 113 can store an indication that channel 0 wrote the most recent set of redundancy metadata to the memory device, and cause the next set of redundancy metadata to be written by channel 1. In alternative embodiments, the size of the set of redundancy metadata is the same size as the size of the memory device that is accessible by a single memory interface channel. Thus, when the set of redundancy metadata is written to the memory device, subsequent data is written at an offset of one memory interface channel. Additional details regarding this offset are described below with reference to FIGS. 2A-5.

FIG. 2A is an example block diagram 200 of a logical representation of various memory planes that are accessible by multiple memory interface channels, according to some aspects of the disclosure. FIG. 2B is described together with FIG. 2A, and illustrates how data 240A-D that is written to data units 231 map to redundancy metadata that is written to redundancy units 232.

The example block diagram 200 of FIG. 2A illustrates memory units 230 of page 220 through page 224 that are each respectively accessible by channel 210 or channel 211. Each memory unit 230 of a respective plane (e.g., page 221, page 222, etc.) are grouped are logically grouped based on which memory interface channel is configured to access the memory unit 230. For example, the memory units U10 and U11 of page 223 are accessible by channel 210, while the memory units U12 and U13 are accessible by the channel 211. In some embodiments, the channel 0 210 and the channel 211 can each include two planes. Illustratively in FIG. 2A, channel 0 210 includes a first plane (U0, U4, R0, U10, U14) and a second plane (U1, U5, R1, U11, U15) and channel 1 211 includes a first plane (U2, U6, U8, U12, R2) and a second plane (U3,U7, U9, U13, R3).

The memory units 230 include data units 231 and redundancy units 232. Data is written to the data units 231, and redundancy metadata for the written data is written to the redundancy units 232. In some embodiments, data is written to the memory device in groups of memory units that are accessible by a single memory interface channel during a memory operation (e.g., as a memory segment). For example, and as illustrated in FIG. 2B, data 240A is written to the memory units U0 through U4 (e.g., the memory segment of page 220 accessible by channel 210). The data 240A maps to the redundancy metadata written to the redundancy unit R0. That is, the redundancy metadata that is generated for the data 240A is written to the redundancy unit R0. Similarly, the data 240B maps to the redundancy metadata written to the redundancy unit R1, the data 240C maps to the redundancy metadata written to the redundancy unit R2, and the data 240D maps to the redundancy metadata written to the redundancy unit R3.

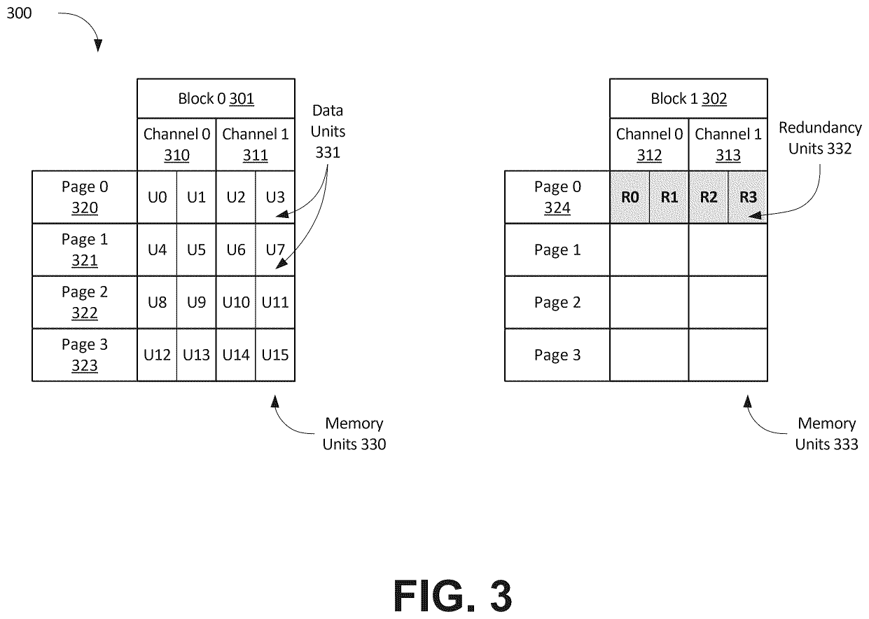

Returning to FIG. 2A, as illustrated the predetermined threshold (e.g., the “write threshold”) for the set of redundancy metadata is two. That is, once two redundancy metadata have been determined for host data (e.g., data 240A and data 240B), the corresponding redundancy metadata is written to the memory device (e.g., at the redundancy units R0 and R1, respectively). It can be appreciated that the predetermined threshold can be greater than two, which is used here only illustratively. Additional details regarding the size of the predetermined threshold are described below with reference to FIGS. 3A-3B.

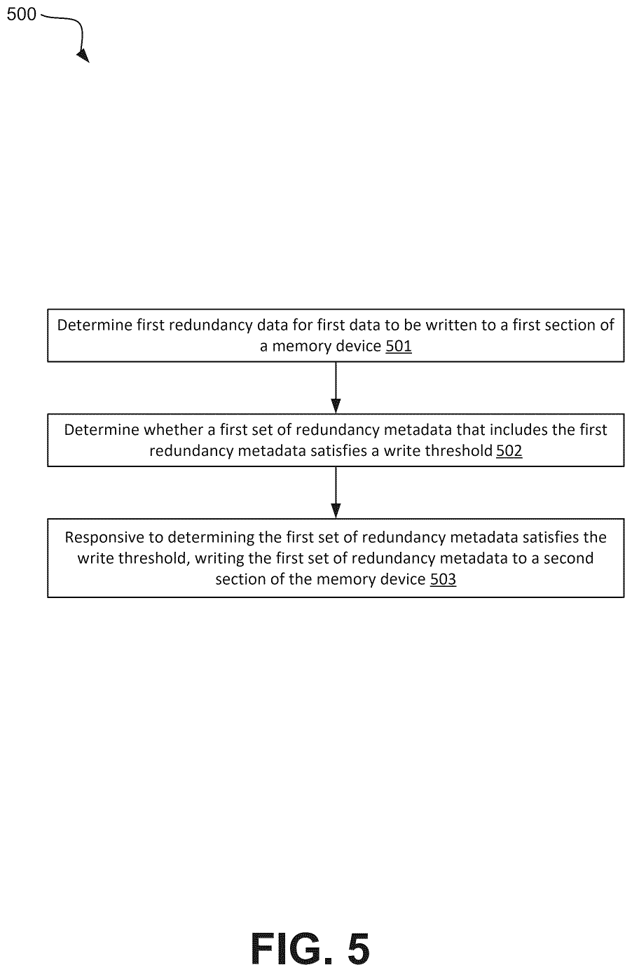

In some embodiments, the redundancy metadata can be stored temporarily, such as in a memory cache, or by the distributed redundancy metadata module 113 of FIG. 1. Additional details regarding the memory cache are described below with reference to FIG. 5. Once the quantity of redundancy metadata (e.g., the number of generated redundancy metadata) satisfies the predetermined threshold, the redundancy metadata is written from the temporary location to the memory device (e.g., in redundancy units 232, respectively).

In some embodiments, the size of the data 240 is of a predetermined size such that it fully fills each plane (e.g., is written to a plane by each channel of the memory device). Consequently, when enough redundancy metadata has been generated to fill a memory segment, and the memory segment is written to the memory device, the starting channel for writing subsequent data of a predetermined size (the size of data 240A, e.g., four memory units) changes. For example, and as illustrated, the data 240A-D is of a size that fills the page 220 (e.g., four memory units), corresponding to both the channel 210 and the channel 211. The data 240A and the data 240B are written to the memory device starting with the channel 210 (e.g., on page 220 and page 221, respectively). Redundancy metadata has been determined for each of the data 240A and the data 240B, and the two redundancy meta data now satisfies the predetermined threshold (e.g., when the predetermined threshold is two redundancy metadata for the set of redundancy metadata). When the redundancy metadata for the data 240A and the data 240B is written by channel 210 to page 222 at the redundancy units R0 and R1, the starting channel for writing data (e.g., data 240) moves from channel 210 to channel 211. Since the next data to be written is data 240C which corresponds to two memory segments, the channel 211 writes a first portion of the data 240C to a memory segment of the page 222 containing data unit U8 and data unit U9 by the channel 211, and the channel 210 writes a second portion of the data 240C to a memory segment of the page 223 containing the data unit U10 and the data unit U11. This causes a natural offset of one channel or one memory segment each time that redundancy metadata is written to the memory units 230 of the memory device, such as the memory device 130 of FIG. 1. Consequently, this causes the redundancy metadata to be written by each memory interface channel sequentially, such that the redundancy metadata is evenly distributed across the memory units 230, and is thus more equally accessible by each memory interface channel of the memory device. In alternative embodiments, the predetermined threshold may be satisfied such that two or more memory interface channels are used to write the redundancy metadata from the redundancy cache to the memory device. The number of channels that are used to write from the redundancy cache to the memory device after the predetermined threshold is satisfied can be configured during production of the memory device according to field and/or end-user requirements or preferences. In such embodiments, the channel offset for the next-write start location is greater than one (e.g., equal to the number of channels used to write the redundancy metadata).

FIG. 3 is an example block diagram 300 of a logical representation of two blocks that each include various memory planes that are accessible by multiple memory interface channels, according to some aspects of the disclosure. FIG. 3 includes similar features and components that are described with reference to FIG. 2A and FIG. 2B. Thus, the same descriptions for FIG. 2A and FIG. 2B can similarly apply to FIG. 3 as applicable. For example, the channel 310 can be the same as or similar to the channel 210, and the page 320 can be the same as or similar to the page 220.

In some embodiments, the distributed redundancy metadata module 113 of FIG. 1 can write data (e.g., host data) to memory units 330 of a first block, such as block 301, and write redundancy metadata generated for the written data to memory units 333 of a second block, such as block 302. In contrast to the embodiments described with reference to FIG. 2A and FIG. 2B, in the embodiments illustrated in FIG. 3, the data units 331 are contained by the block 301 while the redundancy units 332 are contained by the block 302. In some embodiments, this can require the memory sub-system (e.g., memory sub-system 110 of FIG. 1) to simultaneously maintain two open blocks for write operations. In some embodiments, the distributed redundancy metadata module 113 can allow both block 301 and block 302 to be simultaneously accessible for write operations when data is being written to the memory device 130. In some embodiments, multiple blocks worth of data can be written to fill the block 302 with corresponding redundancy metadata. In some embodiments, the blocks with data (such as data 240) and the blocks with redundancy metadata can be located on the same physical die.

When read operations are performed by the memory sub-system on the block 301, there is no unnecessary redundancy metadata to read and process. Data is accessed from the block 301, such as from the data units U0 and U1 on the page 320 via the channel 310, or from the data units U2 and U3 on the page 320 via the channel 311. Similarly, when read operations are performed on the redundancy metadata, only the memory segment that contains the redundancy metadata for damaged or corrupted data is read, as opposed to reading all memory segments in a plane or similar memory structure (as may occur when the redundancy metadata is stored in the same plane or memory segment as the host data used to generate the redundancy metadata). Additionally, this allows for more efficient use of the memory interface channels of the memory device. Since there redundancy metadata is stored in memory locations that are accessible by all memory interface channels (e.g., channel 312 and channel 313) of the memory device for the page 324 of the the block 302, the memory operations to read the redundancy metadata are spread out across multiple channels.

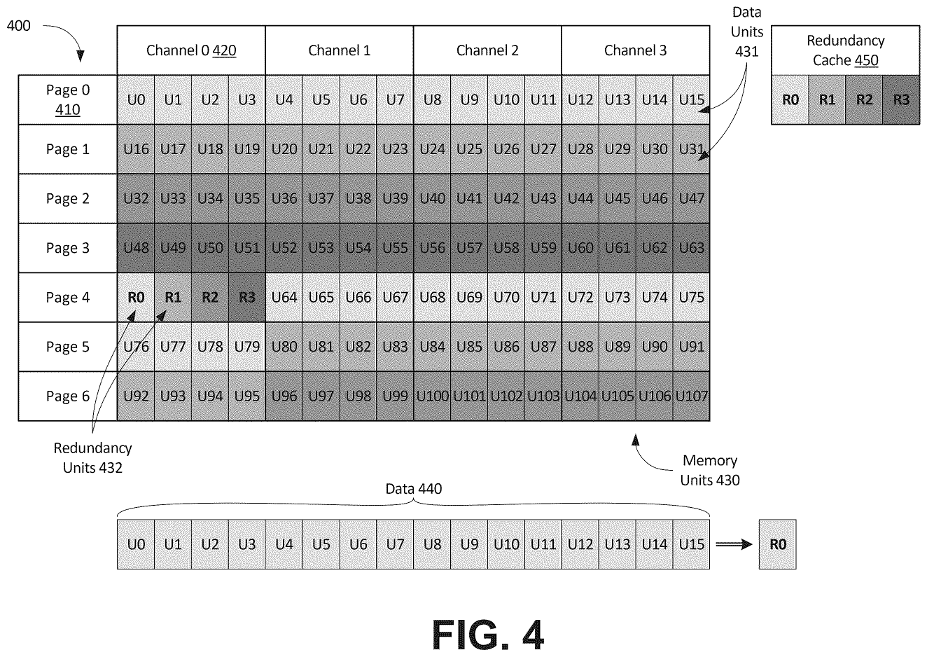

FIG. 4 is an example block diagram 400 of a logical representation of various memory planes that are accessible by multiple memory interface channels, according to some aspects of the disclosure. FIG. 4 includes similar features and components as FIG. 2A and FIG. 2B, albeit with four memory units 430 accessible by each of four channels (e.g., four memory units in each memory segment). As illustrated, the data 440 can correspond to R0. That is, in the illustrative FIG. 4, sixteen data units 431 correspond to one redundancy unit 432. Similarly, as illustrated, the write threshold in FIG. 4 is four, or the same quantity of memory units 430 accessible by a given channel.

FIG. 4 additionally includes a representative illustration of the redundancy cache 450. When data 440 is written to the page 410, the memory sub-system of FIG. 1, or a component of the memory sub-system such as the distributed redundancy metadata module 113, can generate and write redundancy metadata to the redundancy cache 450 at the first available location of the redundancy cache 450 (“R0,” as illustrated). As subsequent data of the same pre-determined width as the data 440 is written to the memory device, additional redundancy metadata can be generated and stored to available locations in the redundancy cache 450. In FIG. 4, these additional data writes, and corresponding generated redundant metadata are indicated by sharing the same shade of gray. As can be seen, writing a memory segment of redundancy metadata to all memory locations accessible by a single channel (here, the channel 420) causes a shift-by-one offset each time the redundancy metadata is written, causing the redundancy metadata to, collectively, evenly distributed across all channels of the memory device.

As described above with reference to FIG. 1, the redundancy cache can be a separate memory device, such as a volatile or short-term memory device. In some embodiments, the redundancy cache is a part of a component such as the distributed redundancy metadata module 113 of FIG. 1. In alternative embodiments, the redundancy cache is a portion of a shared or pooled memory cache for the memory sub-system 110 that is accessible by the distributed redundancy metadata module 113.

In some embodiments, the write threshold can be based on the size of the redundancy cache. That is, the write threshold may be triggered when the redundancy cache 450 is full. In some embodiments, this is one way to control the pre-determined write threshold for the memory sub-system 110. In some embodiments, once the redundancy cache 450 has been filled, the memory sub-system can write the contents of the redundancy cache 450 to a memory segment of the memory device. In the illustrative FIG. 4, the redundancy cache is written in line with other memory segments storing host data (e.g., host data). In alternative embodiments, such as is illustrated with reference to FIG. 3, the redundancy cache 450 can be written to another memory block memory die, or the like. After the memory sub-system has written the contents of the redundancy cache 450 to the memory device (e.g., the memory device 130), the redundancy cache may be cleared. In alternative embodiments, new redundancy metadata may be written over the now-old redundancy metadata. In some embodiments, the size of the redundancy cache is larger than the write threshold. That is, when the write threshold is satisfied, only a portion of the redundancy cache 450 is written to the memory device.

FIG. 5 is a flow diagram of an example method 500 to implement distributed redundancy metadata in a memory sub-system, according to some aspects of the disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 500 is performed by the distributed redundancy metadata module 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 501, the processing logic performing the method 500 determines first redundancy metadata for first data to be written to a first section of a memory device. In some embodiments, a memory sub-system that includes the memory device can include another memory device (e.g., a second memory device). This second memory device can be high-performance volatile or short-term memory that is used as a cache for performing memory operations. In some embodiments, the memory sub-system includes a dedicated redundancy cache for storing generated redundancy metadata before it is written. In alternative embodiments, the memory sub-system uses a shared or pooled cache to temporarily store the generated redundancy metadata. In some embodiments, the contents of the redundancy cache can be overwritten once the write threshold of operation 502 is satisfied and the set of redundancy metadata has been written to the memory device in operation 503. In alternative embodiments, only a portion of the data in the redundancy cache is written when the write threshold is triggered. In some embodiments, the redundancy cache can have a first-in-first-out (FIFO) structure.

At operation 502, the processing logic determines whether a first set of redundancy metadata that includes the first redundancy metadata satisfies a write threshold. In some embodiments, the write threshold can be a number of redundancy metadata that can be written in a single memory operation. In some embodiments, the write threshold can be a number of memory locations that are accessible by a memory interface channel of the memory sub-system when a memory operation is performed. In embodiments with a write cache (as described with reference to operation 501), the write threshold is based on the size of the redundancy cache. That is, when the redundancy cache has been filled, the write threshold is satisfied.

At operation 503, responsive to determining the first set of redundancy metadata satisfies the write threshold, the processing logic writes the first set of redundancy metadata to a second section of the memory device. In some embodiments, the memory device includes memory segments (e.g., groups of memory locations that are written by the same component of a memory interface). The processing logic can write, or cause to be written, the first data to multiple memory segments, as described above with reference to FIGS. 2A-5. The processing logic can write, or cause to be written, the redundancy metadata to one memory segment (e.g., a first memory segment). In some embodiments, each section of the memory device (e.g., the first section storing the data, and the second section storing the redundancy metadata) is located in a separate logical block. For example, data (e.g., host data) can be written to a block, and redundancy metadata that is generated for the host data can be written to another block.

In some embodiments, the memory device is accessible by multiple memory interface channels. Each memory interface channel can access a respective portion of the memory device. That is, a physical location on the memory device is accessible by one of the multiple memory interface channels. In some embodiments, a group of memory locations are accessible by a memory interface channel. When a memory operation is performed, the memory operation may be performed on each memory location that is accessible by the memory interface channel. For example, when a read operation is performed on a memory interface channel, the values of each memory location accessible by the memory interface channel can be returned.

In some embodiments, the processing logic can further receive a request to perform a read operation on a portion of the memory device that includes the first section and the second section. Responsive to receiving the request to perform the read operation, the processing logic can perform a first memory operation to read data from the first section. The processing logic can further perform a second memory operation to skip reading data from the second section.

In some embodiments, the first memory operation can be a read operation that uses all memory interface channels connected to a first memory plane to read the data from the first memory plane. The second memory operation can be a read operation that uses all but one memory interface channel (or a group of memory interface channels) connected to a second memory plane to read the data from the second memory plane. During the second read operation, only memory interface channels that contain non-redundancy metadata for the given memory structure (e.g., a plane) are used to access the stored data. This allows the memory sub-system to skip over the redundancy metadata that is stored in the memory device during read operations, which otherwise would be processed and discarded.

In some embodiments, the redundancy metadata is read by the memory sub-system. For example, if a memory die in the memory device fails, the memory sub-system can recover the information that was written to the failed memory die from redundancy metadata that is written to other memory dies in the memory device, such as using a RAIN technique or operation to read the redundancy metadata from the memory device. In such embodiments, when redundancy metadata has been distributed across the memory device as described herein above, each memory interface channel of the multiple memory interface channels can be used to access the redundancy metadata more quickly than if the redundancy metadata is stored to memory locations that are accessible by one or a few memory interface channels of the memory device.

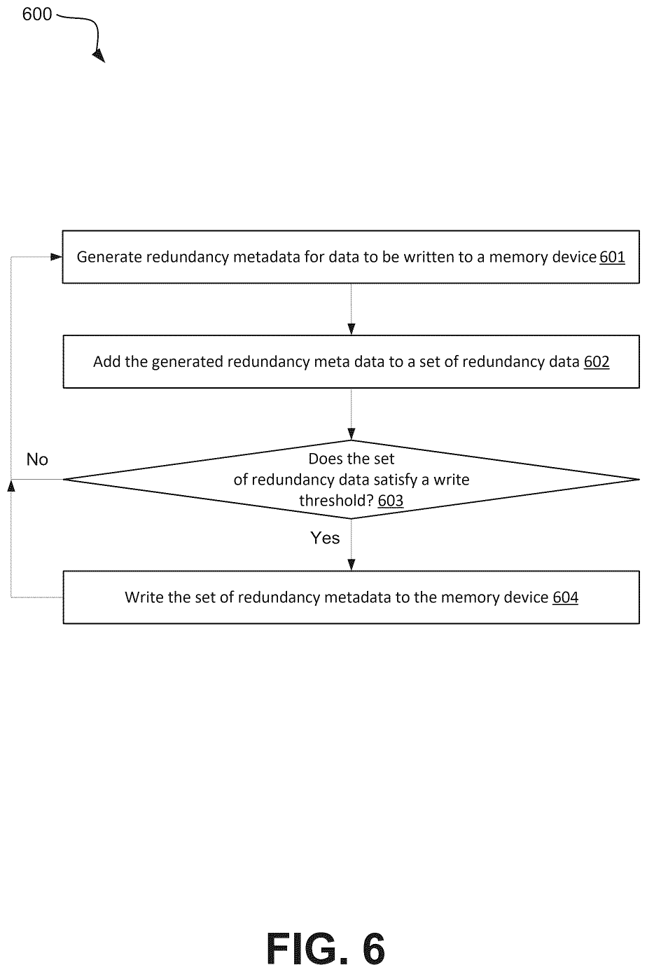

FIG. 6 is a flow diagram of an example method 600 to implement distributed redundancy metadata in a memory sub-system, according to some aspects of the disclosure. The method 600 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 600 is performed by the distributed redundancy metadata module 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 601, the processing logic performing the method 600 generates redundancy metadata for data that is to be written to a memory device.

At operation 602, the processing logic adds the generated redundancy metadata to a set of redundancy metadata.

At operation 603, the processing logic determines whether the set of redundancy metadata satisfies a write threshold. If the set of redundancy metadata satisfies the write threshold, the processing logic proceeds to the operation 604. If the set of redundancy metadata does not satisfy the write threshold, the processing logic returns to the operation 601.

At operation 604, responsive to determining the set of redundancy metadata satisfies the write threshold, the processing logic writes the set of redundancy metadata to the memory device. Responsive to writing the set or redundancy metadata to the memory device, the processing logic returns to the operation 601.

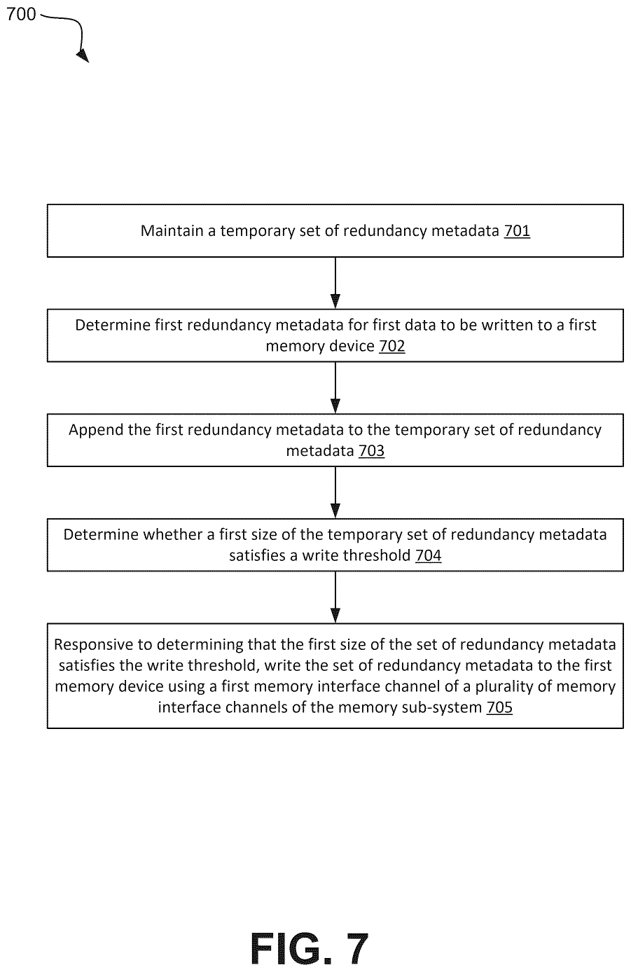

FIG. 7 is a flow diagram of an example method 700 to implement distributed redundancy metadata in a memory sub-system, according to some aspects of the disclosure. The method 700 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some embodiments, the method 700 is performed by the distributed redundancy metadata module 113 of FIG. 1. Although shown in a particular sequence or order, unless otherwise specified, the order of the processes can be modified. Thus, the illustrated embodiments should be understood only as examples, and the illustrated processes can be performed in a different order, and some processes can be performed in parallel. Additionally, one or more processes can be omitted in various embodiments. Thus, not all processes are required in every embodiment. Other process flows are possible.

At operation 701, the processing logic performing the method 700 maintains a temporary set of redundancy metadata.

At operation 702, the processing logic determines first redundancy metadata for first data to be written to a first memory device.

At operation 703, the processing logic appends the first redundancy metadata to the temporary set of redundancy metadata.

At operation 704, the processing logic determines whether a first size of the temporary set of redundancy metadata satisfies a write threshold.

At operation 705, responsive to determining that the first size of the set of redundancy metadata satisfies the write threshold, the processing logic writes the set of redundancy metadata to the first memory device using a first memory interface channel of a plurality of memory interface channels of a memory sub-system.

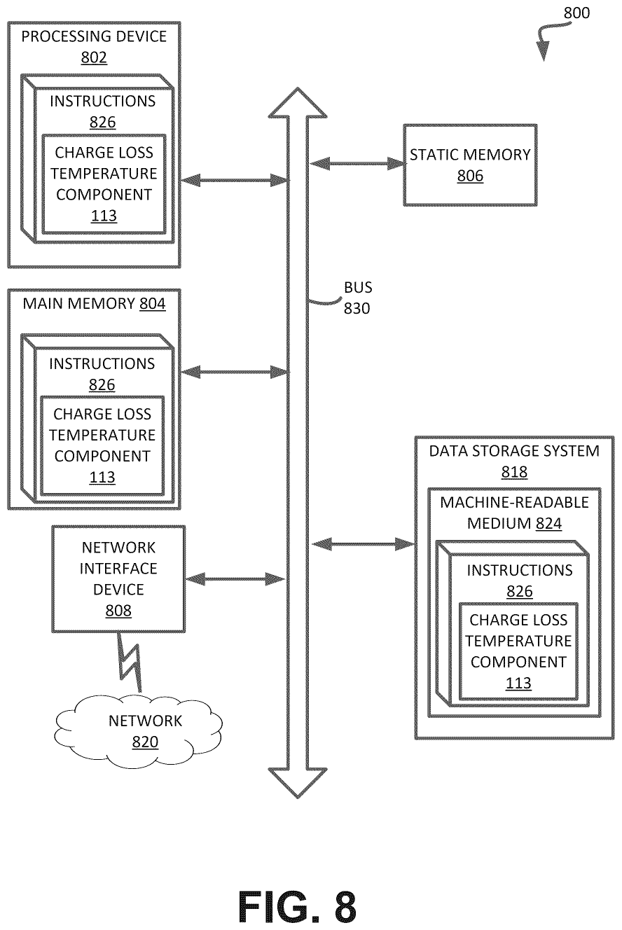

FIG. 8 illustrates an example of a computer system 800 within which a set of instructions, for causing the machine to perform any one or more of the methodologies discussed herein, can be executed, in accordance with aspects of the disclosure. In some embodiments, the computer system 800 can correspond to a host system (e.g., the host system 120 of FIG. 1) that includes, is coupled to, or utilizes a memory sub-system (e.g., the memory sub-system 110 of FIG. 1) or can be used to perform the operations of a controller (e.g., to execute an operating system to perform operations corresponding to the distributed redundancy metadata module 113 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

In some embodiments, computer system 800 includes a processing device 802, a main memory 804 (e.g., read-only memory (ROM), flash memory, dynamic random access memory (DRAM) such as synchronous DRAM (SDRAM) or Rambus DRAM (RDRAM), etc.), a static memory 806 (e.g., flash memory, static random access memory (SRAM), etc.), and a data storage system 818, which communicate with each other via a bus 830.

Processing device 802 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 802 can also be one or more special-purpose processing devices such as an application specific integrated circuit (ASIC), a field programmable gate array (FPGA), a digital signal processor (DSP), network processor, or the like. The processing device 802 is configured to execute instructions 826 for performing the operations and steps discussed herein. The computer system 800 can further include a network interface device 808 to communicate over the network 820.

The data storage system 818 can include a machine-readable storage medium 824 (also known as a computer-readable non-transitory storage medium) on which is stored one or more sets of instructions 826 or software embodying any one or more of the methodologies or functions described herein. In some embodiments, the data storage system 818 can include a computer-readable non-transitory storage medium, and can be operatively coupled to the processing device 802. The instructions 826 can also reside, completely or at least partially, within the main memory 804 and/or within the processing device 802 during execution thereof by the computer system 800, the main memory 804 and the processing device 802 also constituting machine-readable storage media. In some embodiments, the instructions 826 can be refer to executable instructions. The machine-readable storage medium 824, data storage system 818, and/or main memory 804 can correspond to the memory sub-system 110 of FIG. 1.

In some embodiments, the instructions 826 include instructions to implement functionality corresponding to the distributed redundancy metadata module 113 of FIG. 1). While the machine-readable storage medium 824 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Some portions of the preceding detailed descriptions have been presented in terms of algorithms and symbolic representations of operations on data bits within a computer memory. These algorithmic descriptions and representations are the ways used by those skilled in the data processing arts to most effectively convey the substance of their work to others skilled in the art. An algorithm is here, and generally, conceived to be a self-consistent sequence of operations leading to a desired result. The operations are those requiring physical manipulations of physical quantities. Usually, though not necessarily, these quantities take the form of electrical or magnetic signals capable of being stored, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. The present disclosure can refer to the action and processes of a computer system, or similar electronic computing device, that manipulates and transforms data represented as physical (electronic) quantities within the computer system's registers and memories into other data similarly represented as physical quantities within the computer system memories or registers or other such information storage systems.

The present disclosure also relates to an apparatus for performing the operations herein. This apparatus can be specially constructed for the intended purposes, or it can include a general purpose computer selectively activated or reconfigured by a computer program stored in the computer. Such a computer program can be stored in a computer-readable storage medium, such as, but not limited to, any type of disk including floppy disks, optical disks, CD-ROMs, and magnetic-optical disks, read-only memories (ROMs), random access memories (RAMs), EPROMs, EEPROMs, magnetic or optical cards, or any type of media suitable for storing electronic instructions, each coupled to a computer system bus.

The algorithms and displays presented herein are not inherently related to any particular computer or other apparatus. Various general purpose systems can be used with programs in accordance with the teachings herein, or it can prove convenient to construct a more specialized apparatus to perform the method. The structure for a variety of these systems will appear as set forth in the description below. In addition, the present disclosure is not described with reference to any particular programming language. It will be appreciated that a variety of programming languages can be used to implement the teachings of the disclosure as described herein.

The present disclosure can be provided as a computer program product, or software, that can include a machine-readable medium having stored thereon instructions, which can be used to program a computer system (or other electronic devices) to perform a process according to the present disclosure. A machine-readable medium includes any mechanism for storing information in a form readable by a machine (e.g., a computer). In some embodiments, a machine-readable (e.g., computer-readable) medium includes a machine (e.g., a computer) readable storage medium such as a read only memory (“ROM”), random access memory (“RAM”), magnetic disk storage media, optical storage media, flash memory components, etc.

In the foregoing specification, embodiments of the disclosure have been described with reference to specific example embodiments thereof. It will be evident that various modifications can be made thereto without departing from the broader spirit and scope of embodiments of the disclosure as set forth in the following claims. The specification and drawings are, accordingly, to be regarded in an illustrative sense rather than a restrictive sense.

What is claimed is:

1. A memory sub-system comprising:
a first memory device; and
one or more processing devices operatively coupled to the first memory device, the one or more processing devices to perform operations comprising:
maintaining a temporary set of redundancy metadata;
determining first redundancy metadata for first data to be written to the first memory device;
appending the first redundancy metadata to the temporary set of redundancy metadata;
determining whether a size of the temporary set of redundancy metadata satisfies a write threshold; and
responsive to determining that the size of set of redundancy metadata satisfies the write threshold, writing the set of redundancy metadata to the first memory device using a first memory interface channel of a plurality of memory interface channels of the memory sub-system.

2. The memory sub-system of claim 1, the operations further comprising:
writing the first data to the first memory device using each memory interface channel of the plurality of memory interface channels.

3. The memory sub-system of claim 2, the operations further comprising:
receiving a request to perform a read operation on the first memory device; and
responsive to receiving the request to perform the read operation, performing a first memory access operation to read the first data, and skipping the first redundancy metadata.

4. The memory sub-system of claim 1, wherein the first memory device comprises a plurality of memory dies, wherein each memory die is accessible by a respective memory interface channel of the plurality of memory interface channels, wherein the set of redundancy metadata is written to a first memory die corresponding to the first memory interface channel.

5. The memory sub-system of claim 4, wherein each memory die comprises a set of memory planes, wherein the write threshold corresponds to a number of memory planes in the set of memory planes.

6. The memory sub-system of claim 1, further comprising a second memory device, wherein the temporary set of redundancy metadata is stored on the second memory device.

7. The memory sub-system of claim 1, further comprising a second memory device, the operations further comprising:
responsive to determining that the size of the set of redundancy metadata satisfies the write threshold, writing the set of redundancy metadata to the first memory device using the first memory interface channel of the plurality of memory interface channels; and
writing the first data to the first memory device using each memory interface channel of the plurality of memory interface channels.

8. The memory sub-system of claim 1, the operations further comprising:
determining second redundancy metadata for second data to be written to the first memory device;
appending the second redundancy metadata to the temporary set of redundancy metadata;
determining whether a second size of the set of redundancy metadata satisfies the write threshold; and
responsive to determining that the second size of the set of redundancy metadata satisfies the write threshold, writing the set of redundancy metadata to the first memory device using a second memory interface channel of the plurality of memory interface channels of the memory sub-system.

9. A method comprising:
maintaining a temporary set of redundancy metadata;
determining first redundancy metadata for first data to be written to a first memory device of a memory sub-system;
appending the first redundancy metadata to the temporary set of redundancy metadata;
determining whether a size of the temporary set of redundancy metadata satisfies a write threshold; and
responsive to determining that the size of set of redundancy metadata satisfies the write threshold, writing the set of redundancy metadata to the first memory device using a first memory interface channel of a plurality of memory interface channels of the memory sub-system.

10. The method of claim 9, further comprising:
writing the first data to the first memory device using each memory interface channel of the plurality of memory interface channels.

11. The method of claim 10, further comprising:
receiving a request to perform a read operation on the first memory device; and
responsive to receiving the request to perform the read operation, performing a first memory access operation to read the first data, and skipping the first redundancy metadata.

12. The method of claim 9, wherein the first memory device comprises a plurality of memory dies, wherein each memory die is accessible by a respective memory interface channel of the plurality of memory interface channels, wherein the set of redundancy metadata is written to a first memory die corresponding to the first memory interface channel.

13. The memory sub-system of claim 4, wherein each memory die comprises a set of memory planes, wherein the write threshold corresponds to a number of memory planes in the set of memory planes.

14. The method of claim 9, further comprising a second memory device, wherein the temporary set of redundancy metadata is stored on the second memory device.

15. The method of claim 9, further comprising a second memory device, further comprising:
responsive to determining that the size of the set of redundancy metadata satisfies the write threshold, writing the set of redundancy metadata to the first memory device using the first memory interface channel of the plurality of memory interface channels; and
writing the first data to the first memory device using each memory interface channel of the plurality of memory interface channels.

16. The method of claim 9, further comprising:
determining second redundancy metadata for second data to be written to the first memory device;
appending the second redundancy metadata to the temporary set of redundancy metadata;
determining whether a second size of the set of redundancy metadata satisfies the write threshold; and
responsive to determining that the second size of the set of redundancy metadata satisfies the write threshold, writing the set of redundancy metadata to the first memory device using a second memory interface channel of the plurality of memory interface channels of the memory sub-system.

17. A computer-readable non-transitory storage medium comprising executable instructions that, when executed by a controller managing a memory device comprising a plurality of memory cells, causes the controller to perform operations comprising:
maintaining a temporary set of redundancy metadata;
determining first redundancy metadata for first data to be written to a first memory device of a memory sub-system;
appending the first redundancy metadata to the temporary set of redundancy metadata;
determining whether a size of the temporary set of redundancy metadata satisfies a write threshold; and
responsive to determining that the size of set of redundancy metadata satisfies the write threshold, writing the set of redundancy metadata to the first memory device using a first memory interface channel of a plurality of memory interface channels of the memory sub-system.

18. The computer-readable non-transitory storage medium of claim 17, the executable instructions further comprising:
writing the first data to the first memory device using each memory interface channel of the plurality of memory interface channels.

19. The computer-readable non-transitory storage medium of claim 18, the executable instructions further comprising:
receiving a request to perform a read operation on the first memory device; and
responsive to receiving the request to perform the read operation, performing a first memory access operation to read the first data, and skipping the first redundancy metadata.

20. The computer-readable non-transitory storage medium of claim 17, wherein the first memory device comprises a plurality of memory dies, wherein each memory die is accessible by a respective memory interface channel of the plurality of memory interface channels, wherein the set of redundancy metadata is written to a first memory die corresponding to the first memory interface channel.
